(19) United States
(12) Patent Application Publication
(10) Pub. No.: US 2011/0316796 A1
(43) Pub. Date: Dec. 29, 2011

(54) Information Search Apparatus and Information Search Method

(76) Inventor: Jun Kano, Ome-shi (JP)

(21) Appl. No.: 13/101,709

(22) Filed: May 5, 2011

(30) Foreign Application Priority Data
Jun. 29, 2010 (JP) 2010-148321

(51) Int. Cl. G06F 3/041

(52) U.S. Cl. 345/173

(57) ABSTRACT

According to one embodiment, an information search apparatus comprises a touch panel, an extraction module, a storage, an operation module, and a conversion unit. The extraction module is configured to extract keywords from screen information displayed on the touch panel. The storage is configured to store one of the keywords extracted by the extraction module as a search condition element when the one of the keywords is selected by a first touch operation performed on the touch panel. The operation module is configured to edit the search condition element stored in the storage according to a second touch operation performed on the touch panel in order to generate a desired search condition. The conversion unit is configured to convert the desired search condition generated by the operation module to a search formula according to an output destination of the desired search condition.

### CROSS-REFERENCE TO RELATED APPLICATIONS

This application is based upon and claims the benefit of priority from Japanese Patent Application No. 2010-148321, filed Jun. 29, 2010; the entire contents of which are incorporated herein by reference.

### FIELD

Embodiments described herein relate generally to an information search apparatus and an information search method for searching information.

### BACKGROUND

In recent years, widely-available small information apparatuses such as a portable music player and a cellular phone do not have direct character-input device such as a keyboard and a mouse due to limitations of space. Instead, such small information apparatuses use a screen as a touch panel serving as input device. When characters are input with the touch panel, a user has to press virtual keys of a virtual keyboard displayed on the screen, or handwrite characters with a dedicated stylus in a handwriting character input-window displayed on the screen. However, since the small information apparatus has a small touch panel, it is difficult to frequently press virtual keys many times or handwrite small characters in order to input characters.

Such information apparatuses are often connected to a network, and are frequently used to search information on the network. However, it is difficult to frequently input keywords for searching. Although it is necessary to edit a search condition including a keyword in order to efficiently search for the keyword, it is difficult to edit the search condition on a small information apparatus, just as it is difficult to input a keyword on the small information apparatus. The same drawbacks may apply not only to search of information on the network but also search of information within the apparatus.

In the past, an information search apparatus has been suggested to select a term from a page shown in an editor, a browser, and the like and use the selected term as a keyword, so as to allow easy input of the keyword. In this information search apparatus, a user operates an input device, and uses a cursor to specify a range of text displayed on a screen. The search apparatus obtains the character string whose range is specified by the user, and gives the character string as a keyword to another network-connected computer that searched the keyword.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram illustrating an entire search system including an information search apparatus according to an embodiment.

FIG. 2 is an exemplary block diagram illustrating a configuration of the information search apparatus according to the embodiment.

FIG. 3 is an exemplary diagram illustrating an example of display in a keyword input mode of the information search apparatus.

FIG. 4 is an exemplary diagram illustrating an example for generating a search object for AND search.

FIG. 5 is an exemplary diagram illustrating an example for generating a search object for OR search.

FIG. 6 is an exemplary diagram illustrating an example for generating a search object for NOT search.

FIG. 7 is an exemplary diagram illustrating an example for concatenating search objects.

FIG. 8 is an exemplary diagram illustrating an example for dividing a search object.

FIG. 9 is an exemplary diagram illustrating an example for dividing a complex search condition.

FIG. 10 is an exemplary diagram illustrating an example of operation in which search objects are applied to an application.

FIG. 11 is an exemplary diagram illustrating an example of operation in which search objects are applied to a search form.

FIG. 12 is an exemplary diagram illustrating an example of a conversion table of a search condition analysis module.

FIG. 13 is an exemplary diagram illustrating an example of conversion operation of the search condition analysis module.

FIG. 14 is an exemplary diagram illustrating another example of conversion operation of the search condition analysis module.

### DETAILED DESCRIPTION

Various embodiments will be described hereinafter with reference to the accompanying drawings.

In general, according to one embodiment, an information search apparatus comprises a touch panel, an extraction module, a storage, an operation module, and a conversion unit. The extraction module is configured to extract keywords from screen information displayed on the touch panel. The storage is configured to store one of the keywords extracted by the extraction module as a search condition element when the one of the keywords is selected by a first touch operation performed on the touch panel. The operation module is configured to edit the search condition element stored in the storage according to a second touch operation performed on the touch panel in order to generate a desired search condition. The conversion unit is configured to convert the desired search condition generated by the operation module to a search formula according to an output destination of the desired search condition.

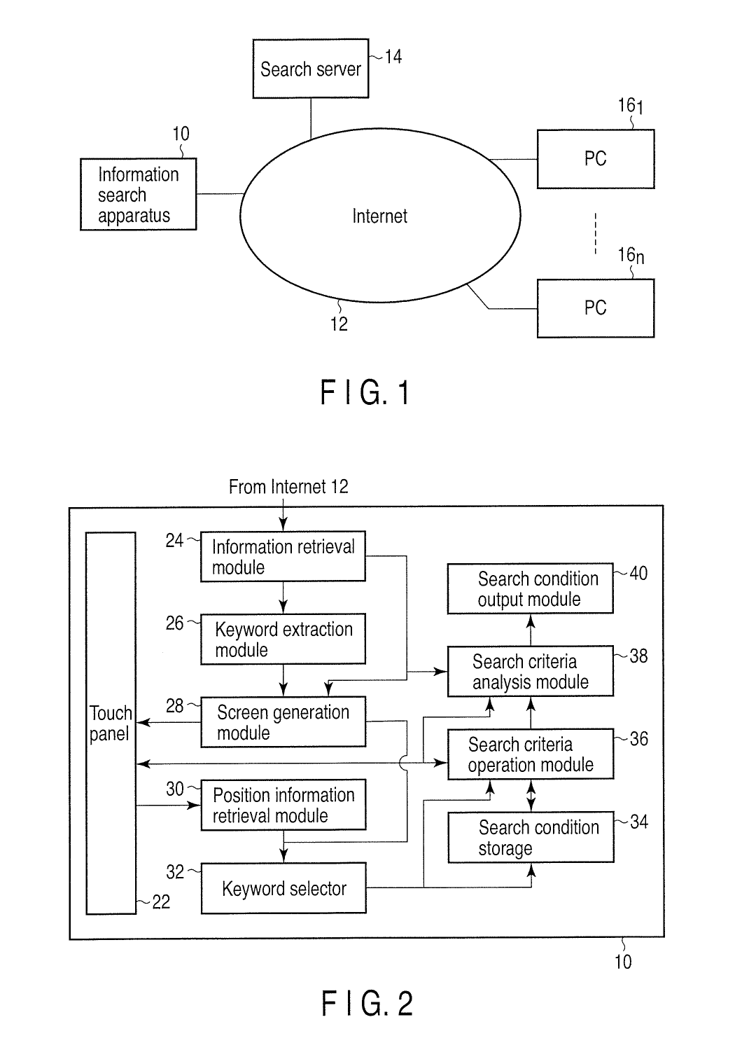

FIG. 1 is a block diagram illustrating an entire search system including an information search apparatus according to an embodiment. In the explanation of the embodiment, the apparatus searches information on the Internet. However, the apparatus can search not only information on the Internet but also information within the apparatus. An information search apparatus 10 constituted by a small information apparatus, such as a portable music player and a cellular phone, is connected to the Internet 12. The Internet 12 is connected to a search server 14 and computers 16₁, . . . , 16ₙ (n is a positive integer).

FIG. 2 is a block diagram illustrating a configuration of the information search apparatus 10.

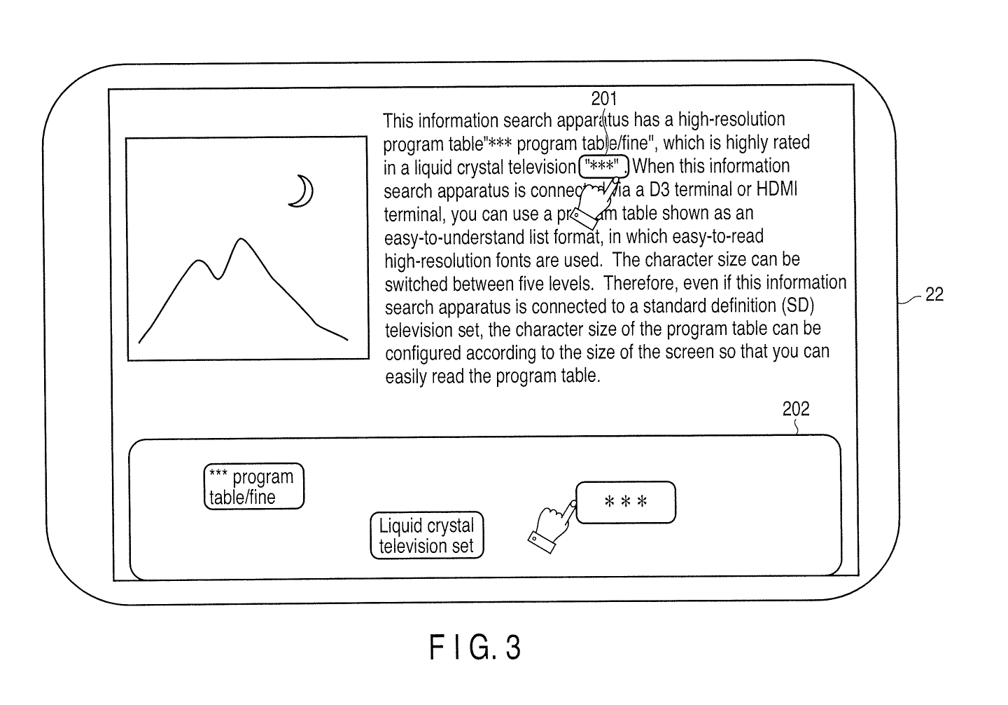

The information search apparatus 10 includes a touch panel 22. The touch panel 22 displays content downloaded from the Internet 12 and the like, and receives touch operation from a user. An information retrieval module 24 obtains information used for generating a screen drawing on the touch panel 22 via the Internet 12. The information search apparatus 10 has a normal mode and an input mode. In the normal mode, the information search apparatus 10 displays information obtained from the Internet 12 as it is. In the input mode, keywords are obtained as search objects from a displayed content, and the search objects, i.e., elements of search condition, are edited according to the search condition (AND search, OR search, and the like). FIG. 3 shows a configuration where the input mode is selected. In the normal mode, data obtained by the information retrieval module 24 (for example, web sites) are displayed on the touch panel 22 as they are.

In the input mode, data obtained by the information retrieval module 24 are input to a keyword extraction module 26. The keyword extraction module 26 extracts, from the input data, a portion displayed as a character string for a user, and analyzes the extracted character string by means of techniques such as morphological analysis, thereby dividing the character string into words. A keyword is extracted based on a part of speech of an obtained word and a relationship with preceding and subsequent words. The data obtained by the information retrieval module 24 and the keywords extracted by the keyword extraction module 26 are provided to a screen generation module 28, and the screen generation module 28 generates a drawing screen displayed on the touch panel 22.

Touch information obtained from touch operation performed by the user with the touch panel is input to a position information retrieval module 30. Position information representing which portion of the screen is selected by the user is identified based on the touch information. The output of the screen generation module 28 and the output of the position information retrieval module 30 are input to a keyword selector 32. The keyword selector 32 determines which keyword in the drawing screen of the touch panel 22 is selected by touch operation of the user, based on the position information identified by the position information retrieval module 30 and the screen information generated by the screen generation module 28. The keywords selected by the keyword selector 32 are provided to a search condition storage 34 and a search condition operation module 36.

When the search condition operation module 36 determines that a keyword selected by the keyword selector 32 is touched by the user and moved (dragged) to a particular region of the touch panel 22 with being touched, the search condition operation module 36 saves the keyword as a search object in the search condition storage 34. When the search condition operation module 36 determines that a search object displayed in the particular region of the touch panel 22 is touched by the user in a particular manner, the search condition operation module 36 applies a predetermined editing operation on the search object according to the manner how it is touched, or generates a search object for a predetermined search condition (AND search, OR search, and the like), and saves the edited or generated search object in the search condition storage 34.

The keyword selected by the keyword selector 32 and the search object edited or generated by the search condition operation module 36 are input to a search condition analysis module 38. The search condition analysis module 38 receives current screen information from the information retrieval module 24 and touch information from the touch panel 22. In a case where an application and a form thereof for actually searching a keyword is identified, the search condition analysis module 38 converts the search object saved in the search condition storage 34 into a search formula suitable for the format and the definition of the identified form and the identified application. In other words, the search object is converted into a character string. The search formula suitable for the application and the form generated by the search condition analysis module 38 is output from a search condition output module 40 to the application and the form.

Subsequently, operation according to the embodiment will be explained. In the normal mode, the information search apparatus 10 displays the content downloaded form the Internet 12 on the touch panel 22 as it is. When the user touches a particular icon on the touch panel 22, the normal mode is switched to the input mode. FIG. 3 shows an example of display of the touch panel 22 in the input mode. A search condition input region 202 is displayed in a lower portion of a viewing screen showing a web site and the like.

When the user finds a keyword candidate in a character string in the content displayed on the viewing screen, the user touches a point in a display area where this candidate is displayed. In a case where the touched point is determined to be included in a character string, and the keyword selector 32 determines that the touched character string is a valid keyword (e.g., noun), the character string including the touched point becomes a selected state, and the character string is encircled by a rectangle 201. In the case as shown in the example, a term “***” is selected as a keyword. When the touch panel 22 is continuously in a touched state, the keyword is continuously in the selected state. When the keyword in the selected state (touched state) is moved (dragged) to the search condition input region 202 in a lower portion of the screen, and the touched state is cancelled in this region 202, the keyword “***” is added as one of search objects, and is saved in the search condition storage 34. The above operation is repeated on desired keyword candidates in the character string displayed on the viewing screen, so that nouns in the character strings are obtained as search objects.

As described above, a keyword is selected by touching a character string displayed on the viewing screen, and the keyword in the selected state is moved to the particular region 202. Then, the selected state is cancelled in this region, so that the selected keyword is saved as a search object in the search condition storage 34. In other words, keywords and search objects can be input without inputting characters.

In the input mode, when a user touches a point in the search condition input region 202, the screen is switched to an editing screen for editing or generating search objects.

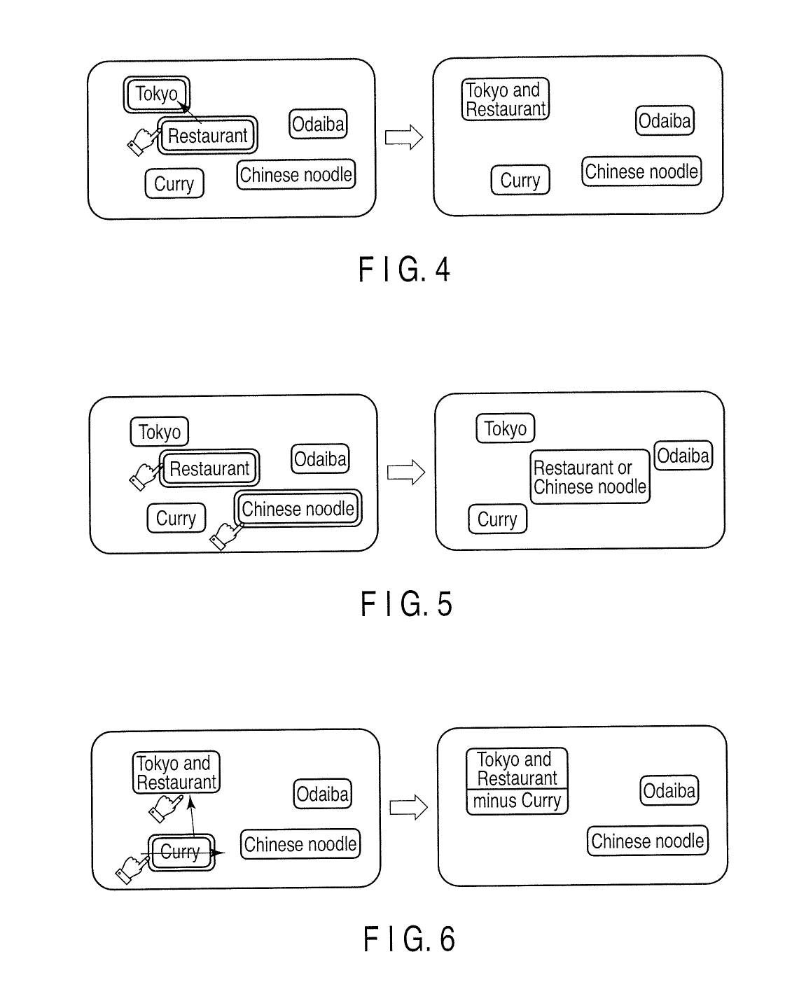

An example for generating a search object for a complex search will be explained with reference to FIG. 4 to FIG. 9. In this example, a search object for a simple search or a search object for a complex search is generated. The later is generated by dividing an already generated search object or editing a keyword.

In the example of FIG. 4 to FIG. 9, a generation/editing screen is displayed on all over the screen of the touch panel 22. Alternatively, editing operation may be performed only in a portion of the screen, such as the search condition input region 202 shown in FIG. 3.

FIG. 4 shows an example for generating a search object for AND search. An example will be explained with reference to FIG. 4, in which there are two search objects, i.e., “Tokyo” and “Restaurant”, and a search object is generated from the two search objects to perform AND search for searching information including a keyword “Tokyo+Restaurant” (in this case, “+” means “AND”).

First, when one of the search objects (for example, “Restaurant”) is touched for a certain period of time (for example, two seconds) or more with a finger, the search object “Restaurant” becomes the selected state. In FIG. 4 to FIG. 9, the object in the selected state is encircled by a double rectangle. In this state (i.e., while “Restaurant” is touched), the search object “Restaurant” in the selected state is moved (dragged) to the other search object (in this example, “Tokyo”) so that both of the search objects are overlapped with each other, and thereafter, the touched state is cancelled. As a result, the two search objects, i.e., “Tokyo” and “Restaurant”, are combined into one search object, i.e., “Tokyo+Restaurant”, for AND search. When one search object for AND search is generated from three or more search objects, a user may render the third or subsequent search object in the selected state, and may repeatedly perform the above operation for placing the third or subsequent search object on an already generated combined search object in order.

Subsequently, FIG. 5 shows an example for generating an object for OR search. An example will be explained with reference to FIG. 5, in which there are two search objects, i.e., “Restaurant” and “Chinese noodle”, and a search object is generated from the two search objects to perform OR search for searching information including a keyword “Restaurant or Chinese noodle” (in this case, “or” means “OR”).

First, when one of the search objects (for example, “Restaurant”) is touched for the certain period of time or more, the search object “Restaurant” becomes the selected state. In this state (i.e., while “Restaurant” is touched), the other search object (in this example, “Chinese noodle”) is also touched for the certain period of time or more with another finger, whereby the other search object “Chinese noodle” also becomes the selected state. Thereafter, the touched state is cancelled for both of the search objects in the selected state. As a result, the two search objects, i.e., “Restaurant” and “Chinese noodle”, are combined into one search object, i.e., “Restaurant or Chinese noodle”, for OR search.

In the above explanation, two search objects are selected successively. Alternatively, they may be selected at the same time. In other words, two search objects are in the selected state at a certain point of time. Likewise, a search object for OR search may be generated from three or more search objects. When the number of combined search objects is equal to or less than the number of search objects that can be touched at the same time, the above operation may be performed once for three or more search objects. Alternatively, when the number of combined search objects is equal to or more than the number of search objects that can be touched at the same time, the above operation may be repeated.

Subsequently, FIG. 6 shows a case where a search object for NOT search is generated. In this example, as shown in FIG. 6, a new search object is generated to exclude search results including a term “Curry” from the search results obtained using the search object “Tokyo+Restaurant”.

First, a search object “Curry” is touched and moved horizontally, whereby a search object for performing NOT search for searching information not including this term is generated. On the screen, a horizontal strikethrough is drawn through “Curry”. Subsequently, the object “Curry” for NOT search is touched for the certain period of time or more, so that this object becomes the selected state. In this state (i.e., while “Curry” is touched), the search object “Curry” is moved to the other search object “Tokyo+Restaurant” so that both of the search objects are overlapped with each other, and thereafter, the touched state is cancelled. As a result, a search object “Tokyo+Restaurant−Curry” (in this example, “−” means “not including”) can be generated to search web pages including the keyword “Tokyo+Restaurant” but not including the keyword “Curry”. When a search object for performing NOT search for searching two or more keywords is generated, the above operation may be repeated.

FIG. 4 to FIG. 6 relate to generation of a search object for executing a specified search condition. Subsequently, concatenating and dividing of search objects will be explained.

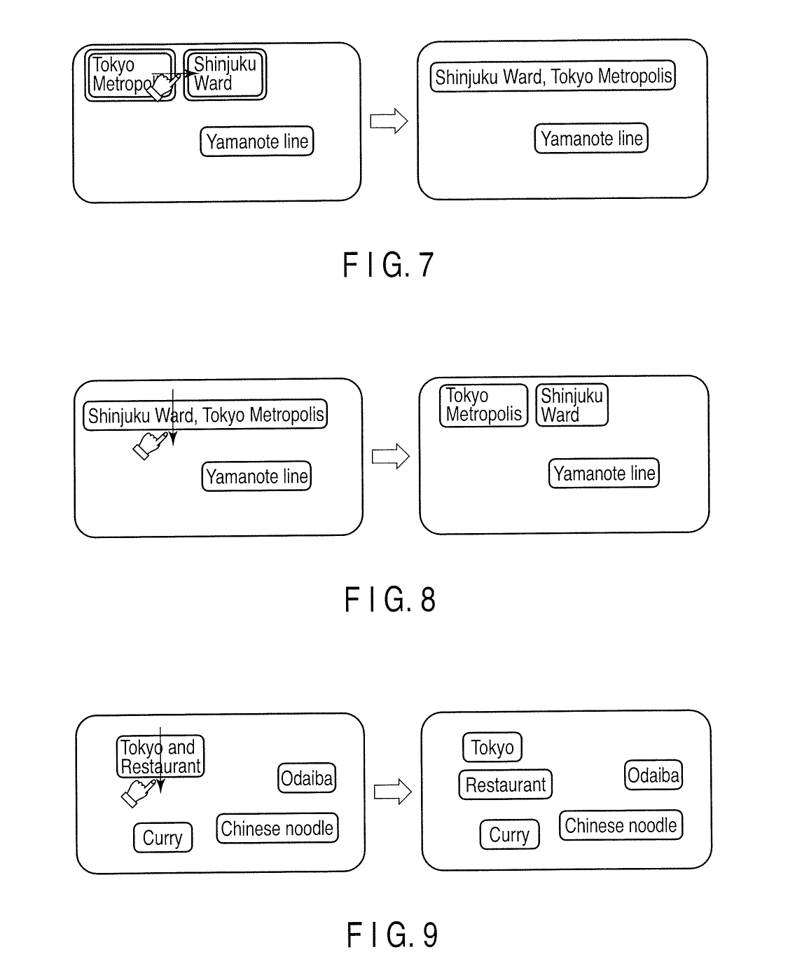

FIG. 7 shows an example where a new character string is generated by concatenating two or more character strings serving as a search condition. In the example of FIG. 7, there are two search objects, i.e., “Tokyo Metropolis” and “Shinjuku Ward”, and one search object “Shinjuku Ward, Tokyo Metropolis” is generated from the two search objects. In this case, as shown in FIG. 7, first, at least one of the search object “Tokyo Metropolis” and the search object “Shinjuku Ward” is moved, so that they are placed adjacent to each other in the order in which the two search objects are concatenated. A search object can be moved as follows. As explained in FIG. 4, the search object concerned is touched for the certain period of time or more, so that the search object becomes the selected state. While the search object is still touched, the search object is moved (dragged) to a position adjacent to the other search object, at which the touched state is cancelled. Thereafter, a touch operation is performed to make a horizontal movement across the two adjacent search objects, i.e., “Tokyo Metropolis”, “Shinjuku Ward”, multiple times in a reciprocal manner. As a result, the two search objects are concatenated, and the new search object “Shinjuku Ward, Tokyo Metropolis” is generated. In this example, the above operation may be repeated when three or more search objects are combined.

In contrast to FIG. 7, FIG. 8 shows an example for generating two search objects upon dividing a single search object. In the example of FIG. 8, there is a search object, i.e., “Shinjuku Ward, Tokyo Metropolis”, and this is divided into two search objects, i.e., “Tokyo Metropolis” and “Shinjuku Ward”. In this case, as shown in FIG. 8, a touch operation of vertical movement (operation for moving a finger across Tokyo Metropolis and Shinjuku Ward) is performed at a point at which the character string displayed as “Shinjuku Ward, Tokyo Metropolis” is to be divided (in this example, a point between “Tokyo Metropolis” and “Shinjuku Ward”). As a result, one search object “Shinjuku Ward, Tokyo Metropolis” is divided, whereby two search objects, i.e., “Tokyo Metropolis” and “Shinjuku Ward”, are generated.

The touch processing of FIG. 8 can be applied to not only dividing of a search object but also dividing of a complex search object for a predetermined search condition as explained in FIG. 4, FIG. 5, FIG. 6, and the like. For example, the touch processing of FIG. 8 can be applied to the case where the two search objects for AND search as explained in FIG. 4 are divided into the respective search objects.

In FIG. 9, a search object “Tokyo+Restaurant” for AND search is divided into two search objects, i.e., “Tokyo” and “Restaurant”. In this case, like the case of FIG. 8, the complex search object can be divided into respective search objects by performing the touch operation of vertical movement on the search object.

When the single search object as shown in FIG. 8 is divided, the touch operation should be performed precisely at the position where the search object is divided. In contrast, when the complex search object as shown in FIG. 9 is divided, search objects constituting the complex search object are already known. In this case, therefore, the complex search object can be correctly divided by performing a touch operation for moving a finger across the region in which the complex search object is drawn, without precisely specifying the dividing point. The direction of the touch operation is not limited to the vertical direction. The direction of the touch operation may be a horizontal direction or any other direction. In other words, the complex search object can be divided by performing operation for moving a finger, in any direction, across the region in which the complex search object is drawn.

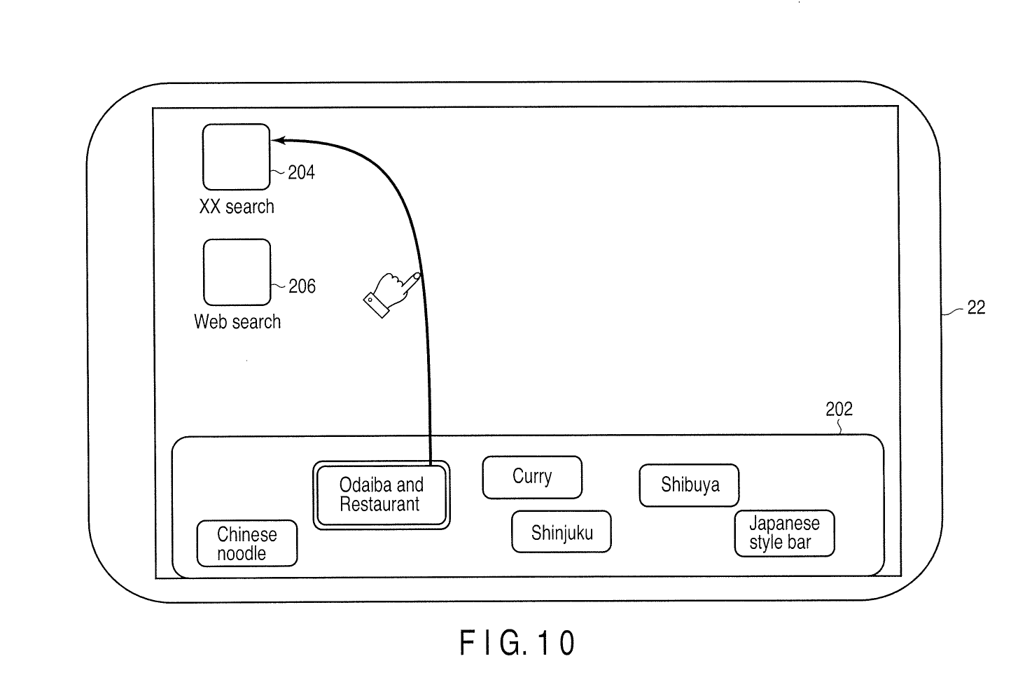

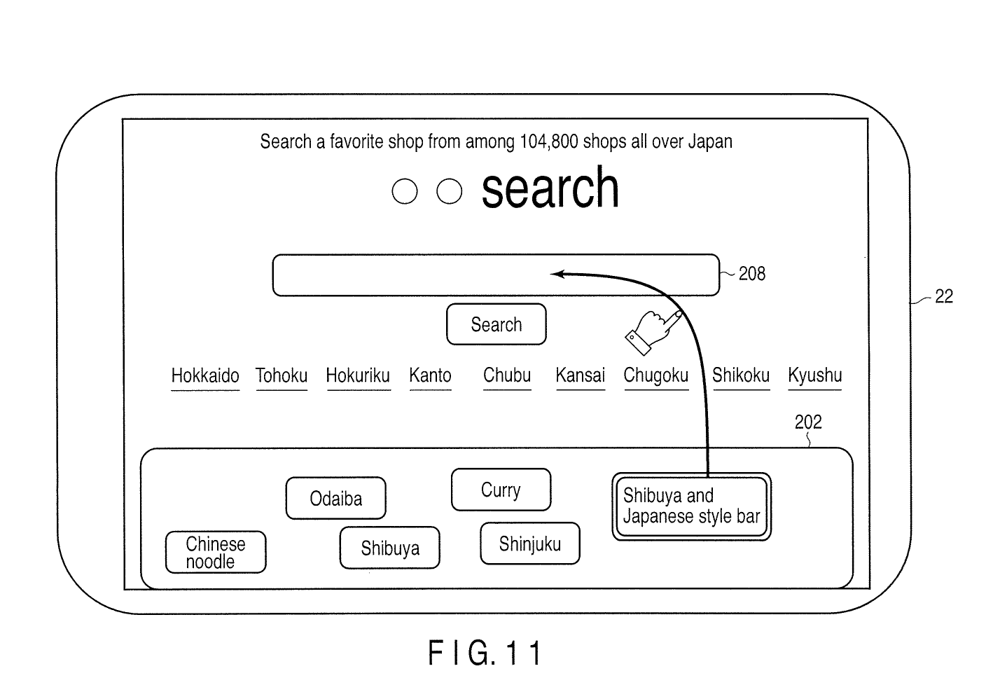

FIG. 10 and FIG. 11 are examples of information search actually using search objects. FIG. 10 shows an example where icons 204 and 206 and the like for a search application are arranged on a desktop, and the search condition input region 202 is arranged in a lower portion thereof. In the search condition input region 202, search objects are displayed. Among them, a search condition “Odaiba+Restaurant” for AND search is touched for a certain period of time or more, whereby the search condition becomes a selected state. Subsequently, while this touched state is maintained, the search object “Odaiba+Restaurant” is moved (dragged) to the icon 204 of the search application to be executed (in this case, application called “XX search”), and then, the touched state is cancelled on the icon 204. As a result, the search object “Odaiba+Restaurant” is supplied to the application called “XX search”.

The application (not shown in FIG. 2) having received the search object “Odaiba+Restaurant” gives identification information representing the application concerned and the received search object to the search condition analysis module 38. The search condition analysis module 38 converts the received search object into a character string or a data format that can be interpreted by the application, according to a conversion rule for the corresponding application stored therein. Thereafter, this character string or data as well as the identification information of the application are supplied to the search condition output module 40. The search condition output module 40 having received them determines an output destination (application) based on the received identification information of the application, and supplies this character string or data to the application.

As described above, the search object generated by the search condition operation module 36 is in a format that can be easily seen and understood on a display screen of the touch panel 22. Therefore, when the search object is supplied to the application and the like, the search object is converted into the character string that can be interpreted by the application and the like. Therefore, one search object can be used by a plurality of applications, whereby the efficiency of searching can be enhanced.

FIG. 11 is basically the same as FIG. 10. In the example of FIG. 11, a search object is not moved to the icon of the search application but is moved to an input area (form) 208 for search objects after the application is started. Also in this example, a search object “Shibuya+Japanese style bar” for AND search is selected from among search objects displayed in the search condition input region 202, and the search object “Shibuya+Japanese style bar” is touched for a certain period of time or more, whereby the search object becomes a selected state. Subsequently, while this touched state is maintained, the search object “Shibuya+Japanese style bar” is moved to the input area 208, and then, the touched state is cancelled. As a result, the search object “Shibuya+Japanese style bar” is supplied to the application.

The application having received the search object “Shibuya+Japanese style bar” gives the identification information representing the application, the identification information of the input area 208, and the received search object to the search condition analysis module 38. The search condition analysis module 38 converts the received search object into a character string or a data format that can be interpreted by the application and/or input area according to a conversion rule for each input area and/or each application stored therein. Thereafter, this character string or data as well as the identification information of the application and/or the input area are supplied to the search condition output module 40. The search condition output module 40 having received them determines an output destination (application and/or input area) based on the received identification information of the application and/or the input area, and supplies this character string or data to the application.

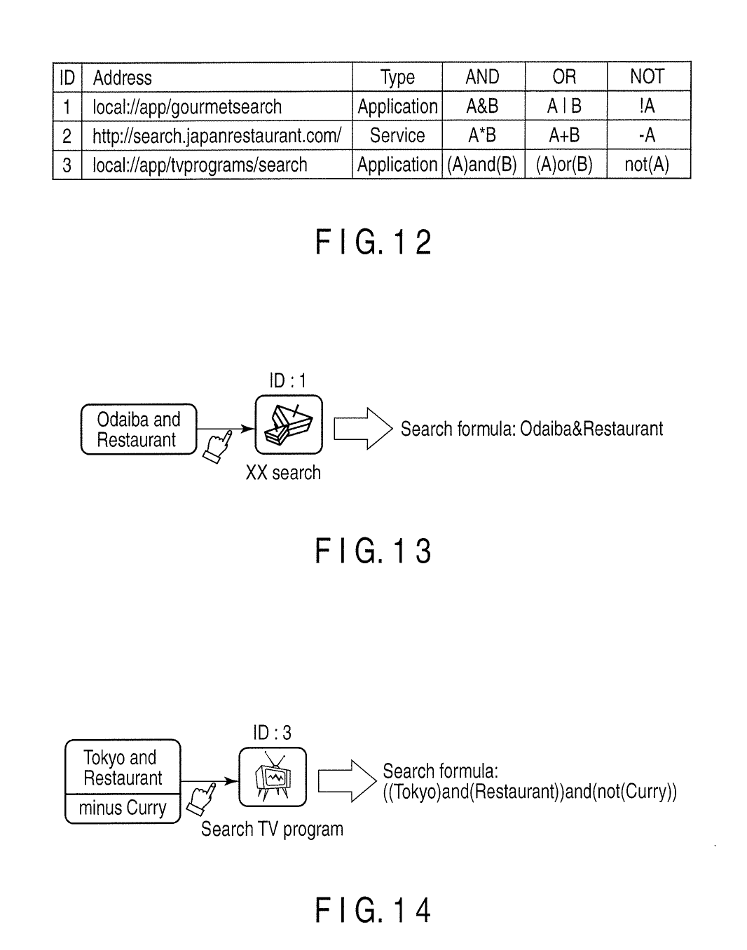

FIG. 12 is an example of a conversion table of the search condition analysis module 38. The conversion table includes an expression of search condition (search formula) for each search service on the Internet 12 or application installed in the apparatus concerned. An application having an identification information “1” is an XX search application installed in the apparatus concerned. A Japanese Restaurant search service having an identification information “2” is a search service that is not installed in the apparatus concerned but is available on the network. An application having an identification information “3” is a TV program search application installed in the apparatus concerned.

In the XX search application having the identification information “1” installed in the apparatus concerned, AND search is represented as “A&B”, OR search is represented as “A*B”, and NOT search is represented as “!A”. In the Japanese Restaurant search service having the identification information “2”, AND search is represented as “A*B”, OR search is represented as “A+B”, and NOT search is represented as “−A”. The TV program search application having the identification information “3”, AND search is represented as “(A)and(B)”, OR search is represented as “(A)or(B)”, and NOT search is represented as “not(A)”.

Therefore, when the search object “Odaiba+Restaurant” is supplied to the XX search application, this is converted into a search formula “Odaiba&Restaurant” and is supplied to the XX search application as shown in FIG. 13.

When the search object “Tokyo+Restaurant−Curry” is supplied to the TV program search application, this is converted into a search formula “((Tokyo)and(Restaurant))and(not(Curry))” and is supplied to the TV program search application as shown in FIG. 14.

As described above, according to the present embodiment, a keyword is selected by touching a character string in the viewing screen, and the keyword is moved to the particular region while it is in the selected state. Then, the selection state is cancelled in this region, whereby the selected keyword is saved as a search object in the search condition storage. Therefore, keywords and search objects can be input without inputting characters. Further, by means of intuitive operation performed on search objects displayed on the touch panel, a plurality of search objects are combined, and combined objects and a single search object are divided, so that the search objects can be edited, and the search condition (AND search, OR search, and the like) can be specified. Therefore, a complicated search can be easily performed. Still further, the search objects are saved, which eliminates the necessity of inputting a search condition for frequently-searched terms and the like on every occasion. Therefore, the efficiency of searching can be enhanced. Moreover, one search object can be used by a plurality of applications. Therefore, this also enhances the efficiency of searching.

In the above embodiments, only character strings are used as the search condition. However, not only character information but also date information and category information generally-used for searching may also be used as the search condition. In the above embodiments, the search condition is analyzed based on the conversion table stored within the apparatus concerned (search condition analysis module 38). Alternatively, the following modifications may be considered. For example, the search condition may be analyzed by the search server, and the result of the analysis may be returned back to the apparatus. In another modification, the server may perform processing up to issuing of a search request, and only the search result thereof may be returned back to the apparatus.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information search apparatus comprising:
a touch panel;
an extraction module configured to extract keywords from screen information displayed on the touch panel;
a storage configured to store one of the keywords extracted by the extraction module as a search condition element when the one of the keywords is selected by a first touch operation performed on the touch panel;
an operation module configured to edit the search condition element stored in the storage according to a second touch operation performed on the touch panel in order to generate a desired search condition; and
a conversion unit configured to convert the desired search condition generated by the operation module to a search formula according to an output destination of the desired search condition.

2. The apparatus of claim 1, wherein
the touch panel is configured to display content;
the extraction module is configured to extract words from the content displayed on the touch panel;
the storage is configured to store one of the words extracted by the extraction module, the one being displayed at a position where the first touch operation is performed on the touch panel, as the search condition element when the one of the words is selected by a third touch operation performed on the touch panel; and
the conversion unit is configured to recognize the output destination of the desired search condition based on a fourth touch operation performed on the touch panel.

3. The apparatus of claim 1, wherein
the apparatus is configured to be connected to a network; and
the touch panel is configured to display content downloaded from the network.

4. The apparatus of claim 1, wherein
the output destination of the desired search condition comprises a search application;
the touch panel is configured to display at least one of an icon representing the search application and a search form of the search application; and
the conversion unit is configured to recognize the output destination of the desired search condition based on at least one of the icon and the form on which a touch operation is performed.

5. The apparatus of claim 1, wherein
the touch panel is configured to display first and second character strings;
the second touch operation comprises selecting the first character string and placing the first character string with being selected onto the second character string; and
the operation module is configured to generate a search condition for searching information including the first character string and the second character string.

6. The apparatus of claim 1, wherein
the touch panel is configured to display first and second character strings;
the second touch operation comprises selecting the first character string and the second character string; and
the operation module is configured to generate a search condition for searching information including the first character string or the second character string.

7. The apparatus of claim 1, wherein
the touch panel is configured to display a character string;
the second touch operation comprises tracing the character string; and
the operation module is configured to generate a search condition for searching information which does not include the character string.

8. The apparatus of claim 1, wherein
the touch panel is configured to display first and second character strings;
the second touch operation comprises moving the first character string adjacent to the second character string and tracing the first character string and the second character string; and
the operation module is configured to generate a new search condition element including the first character string and the second character string.

9. The apparatus of claim 1, wherein
the touch panel is configured to display a character string;
the second touch operation comprises cutting the character string between any two characters into a first character string and a second character string; and
the operation module is configured to generate a first search condition element comprising the first character string and a second search condition element comprising the second character string.

10. The apparatus of claim 1, wherein
the touch panel is configured to display a complex search condition comprising a first condition and a second condition;
the second touch operation comprises cutting a display area of the complex search condition; and
the operation module is configured to divide the complex search condition into the first condition and the second condition.

11. An information search method for an information search apparatus comprising a touch panel, the method comprising:
extracting keywords from screen information displayed on the touch panel;
storing one of the keywords extracted by the extraction module as a search condition element when the one of the keywords is selected by a first touch operation performed on the touch panel;
editing the stored search condition element according to a second touch operation performed on the touch panel in order to generate a desired search condition; and
converting the desired search condition to a search formula according to an output destination of the desired search condition.

12. The method of claim 11, wherein
the extracting comprises extracting words from content displayed on the touch panel;
the storing comprises storing one of the extracted words, the one being displayed at a position where the first touch operation is performed on the touch panel, as the search condition element when the one of the words is selected by a third touch operation performed on the touch panel; and
the converting comprises recognizing the output destination of the desired search condition based on a fourth touch operation performed on the touch panel.
